(19) United States
(12) Patent Application Publication
(10) Pub. No.: US 2025/0299055 A1
(43) Pub. Date: Sep. 25, 2025

(54) Scaling Reinforcement Learning With AI Feedback

(71) Applicant: Google LLC, Mountain View, CA (US)

(72) Inventors: Samrat Phatale, Palo Alto, CA (US); Harrison Lee, Denver, CO (US); Hassan Mansoor, London (GB); Kellie Lu, Stockton, CA (US); Thomas Mesnard, Paris (FR); Johan Ferret, Paris (FR); Colton Bishop, San Francisco, CA (US); Ethan Hall, Jersey City, NJ (US); Victor Carbune, Zurich (CH); Abhinav Kumar Rastogi, Mountain View, CA (US); Sushant Prakash, Scarsdale, NY (US); Mo Azar, Seattle, WA (US); Zhaohan Daniel Guo, London (GB); Andrea Michi, London (GB); Nicolas Perez Nieves, Cambridge (GB); Marco Selvi, London (GB)

(21) Appl. No.: 18/609,083

(22) Filed: Mar. 19, 2024

(51) Int. Cl. G06N 3/092; G06N 3/0475

(52) U.S. Cl. CPC G06N 3/092; G06N 3/0475

(57) ABSTRACT

Aspects of the disclosure are directed to using reinforcement learning to train one or more machine learning models based on reward data that is model generated. The reward data is generated by a generative model, such as a large language model, in response to a prompt to provide respective reward scores for model-generated responses to a task. Since generating preference labels and training of a reward model can be bypassed here, the machine learning models can be trained using reinforcement learning with less processing cost and memory usage.

### BACKGROUND

Generative models, such as large language models, are powerful but can lack an alignment with human preferences. To address this, generative models can be trained using reinforcement learning from human feedback (RLHF) to align the generative models to human preferences. RLHF is performed by generating a set of responses from the model, having humans generate preference labels, e.g., “preferred” or “not preferred” for each response of the set, and then training another “reward” model to generate a reward score based on the preference labels. Reinforcement learning is then performed on the generative model using the reward model. RLHF can improve alignment of the generative models to human preferences, but lacks scalability as RLHF depends on a human effort to have numerous responses labeled. To address scalability, generative models can be trained using reinforcement learning from artificial intelligence feedback (RLAIF). Here, a generative model is used to generate the preference labels rather than humans. However, generating the preference data, even when AI generated, as well as training the reward model, requires significant processing power and memory usage.

### BRIEF SUMMARY

Aspects of the disclosure are directed to using reinforcement learning to train one or more machine learning models based on reward data that is model generated. The reward data is generated by a generative model, such as a large language model, in response to a prompt to provide respective reward scores for model-generated responses to a task. Example tasks can include summarization or dialogue generation. Machine learning models trained in this manner can have comparable or improved accuracy compared to machine learning models trained in alternative manners like RLHF or RLAIF. Since generating preference labels and training of a reward model can be bypassed here, the machine learning models can be trained using reinforcement learning with less processing cost and memory usage.

An aspect of the disclosure provides for a method for scaling reinforcement learning including: receiving, by one or more processors, model-generated responses to a task and a prompt associated with providing respective reward scores for the model-generated responses; processing, by the one or more processors, the model-generated responses and the prompt using a generative model to generate reward data indicative of the reward scores; training, by the one or more processors, one or more machine learning models via reinforcement learning based on the reward data; and outputting, by the one or more processors, the one or more trained machine learning models. Another aspect of the disclosure provides for a system including: one or more processors; and one or more storage devices coupled to the one or more processors and storing instructions that, when executed by the one or more processors, cause the one or more processors to perform operations for the method for scaling reinforcement learning. Yet another aspect of the disclosure provides for a non-transitory computer readable medium for storing instructions that, when executed by one or more processors, cause the one or more processors to perform operations for the method for scaling reinforcement learning.

In an example, the generative model is at least one of a large language model, large foundation model, or large graphical model.

In another example, the prompt includes instructions for the generative model to rate a quality of the respective responses. In yet another example, the instructions include rating the quality of the respective responses on a scale. In yet another example, the instructions further include one or more attributes for the generative model to consider in rating the quality of the respective responses. In yet another example, the instructions further include descriptions for the one or more attributes.

In yet another example, processing the model-generated responses and the prompt further comprises calculating a probability weighted average of ratings to generate the reward scores. In yet another example, processing the model-generated responses and the prompt further includes normalizing the probability weighted average of ratings.

In yet another example, the one or more machine learning models are trained via reinforcement learning based on policy-gradient-based techniques.

In yet another example, the task includes at least one of summarization or dialogue generation.

### BRIEF DESCRIPTION OF THE DRAWINGS

FIG. 1 depicts a block diagram of an example reinforcement learning trainer according to aspects of the disclosure.

FIG. 2 depicts a block diagram of a reward score generation system according to aspects of the disclosure.

FIG. 3 depicts a block diagram of an example environment for implementing a reward score generation system according to aspects of the disclosure.

FIG. 4 depicts a block diagram of one or more machine learning model architectures according to aspects of the disclosure.

FIG. 5 depicts a flow diagram of an example process for training a machine learning model using reinforcement learning according to aspects of the disclosure.

### DETAILED DESCRIPTION

The technology relates generally to training one or more machine learning models via reinforcement learning based on model-generated reward data. The reward data is generated by a large generative model, such as a large language model, in response to a prompt. The reward data can include a numerical score or other value or signal, which can correlate to how responsive a response is to a prompt to perform a task. A machine learning model trained according to reinforcement learning is trained to maximize the reward value or signal associated with model outputs to prompts to perform various tasks. Reinforcement learning with model-generated reward data can achieve comparable or improved accuracy with less processing cost and memory usage, as generating preference labels for training a reward model, as well as the training of the reward model itself, can be bypassed.

The reward data is generated by prompting a general usage generative model, such as a large language model. By general usage, the generative model is not fine-tuned for a particular task. The reward data can also be generated by prompting a generative model fine-tuned to generate reward scores for reinforcement learning training.

The generative model is prompted to provide a reward score for a model-generated response for a task, e.g., summarization. The prompt includes instructions for the generative model to rate the responses to indicate the quality of the respective responses. For example, rating a response can be based on a scale, e.g., a scale of 1-10 where 1 is lower quality and 10 is higher quality. The prompt also includes one or more attributes for the generative model to consider when rating the response. Example attributes can include length or accuracy of the response. The prompt can further include descriptions for the respective attributes.

The generative model can process the prompt based on a probability distribution over each potential rating, such as over the scale of 1-10. The generative model can calculate a probability weighted average of ratings to generate respective reward scores for each of the responses. The generative model can further normalize the probability weighted average of ratings in generating the reward scores. The generative model can perform precise calculations or generate approximations of an input calculation within a predetermined or tolerated margin of error. The generative model can be configured to perform input calculations using a combination of symbolic or pattern-based approaches and/or using traditional numerical computation.

The generative model can output the rewards score as reward data. The reward score can be a scalar number that reflects how well a process was executed. Here, the reward score indicates how well the generative model performed in generating its responses. Since the generative model is outputting reward scores instead of preference labels for training a reward model, reinforcement learning can be implemented with less processing cost and memory usage.

One or more machine learning models can be trained via reinforcement learning using the generative model as a reward model based on the prompt to generate reward scores. Reinforcement learning algorithms can utilize the reward scores to train the one or more machine learning models by aiming to boost an average of the reward scores. For example, the one or more machine learning models can be trained with policy-gradient algorithms, such as a reinforce algorithm with a value head adapted to a language domain or any policy optimization algorithm. Policy optimization may refer to policy-gradient training where a model gathers scores for a plurality of sequences at once and then provides an estimated gradient direction that optimizes a reward function. The current policy can be updated in accordance with the gradient direction.

Once sufficiently trained, for example, after a predetermined number of training iterations, meeting a predetermined performance metric, or not improving more than a predetermined minimum threshold between training iterations, the one or more machine learning models can be output for use in a variety of applications, such as text generation tasks like summarization or dialogue generation.

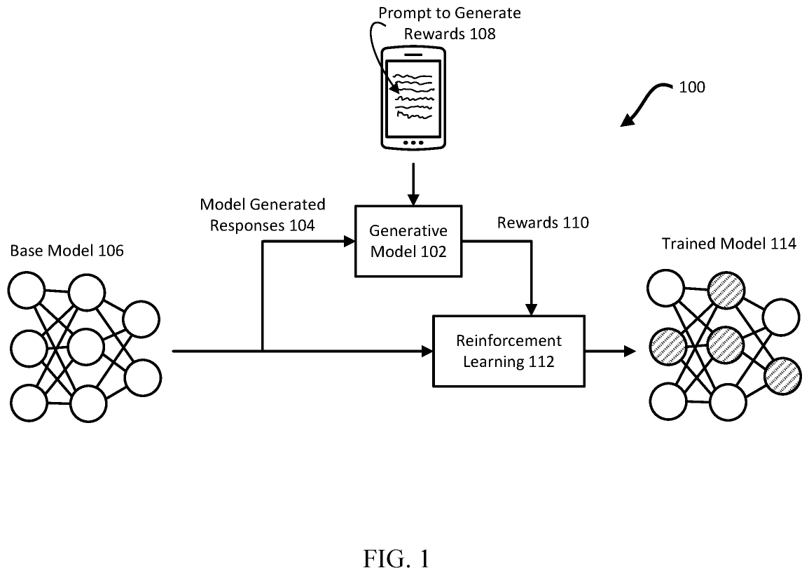

FIG. 1 depicts a block diagram of an example reinforcement learning trainer 100 for training one or more machine learning models via reinforcement learning. The reinforcement trainer 100 can include one or more generative models 102. The generative models 102 can be general usage models and/or can be model fine-tuned to the task of generating rewards for reinforcement learning. If fine-tuned, the generative models 102 can be trained on real-world and/or synthetic data associated with preferences for model-generated responses to various downstream tasks. Example generative models can include large generative models, such as large language models, large foundation models, and/or large graphical models.

The generative models 102 can receive responses 104 generated from one or more base models 106 to be trained via reinforcement learning. For example, the one or more base models 106 can be supervised fine-tuning (SFT) models pre-trained for specific downstream tasks using labeled data. Example downstream tasks can include text generation tasks, such as summarization or dialogue generation. The generative models 102 can further receive a prompt 108 to generate rewards 110 from the model-generated responses 104. The prompt 108 can include instructions for the generative models 102 to rate a quality of the model-generated responses 104 and attributes or factors to consider when rating the quality of the model-generated responses 104.

In response to the model-generated responses 104 and the prompt 108, the generative models 102 can process the responses 104 based on the prompt 108 to output rewards 110. The rewards 110 can indicate how well the base models 106 performed in generating the responses 104, such as with respect to a particular downstream task. The generative models 102 can provide the rewards 110 to the base model 106 for training via reinforcement learning 112. Any reinforcement learning can be utilized, such as training with a goal to increase an average of reward scores. For example, the generative models 102 can train the base models 106 using policy-gradient based training based on the rewards 110. Once sufficiently trained, the base models 106 can be output as trained models 114, such as for one or more of the downstream tasks. The trained models 114 can perform the downstream tasks with comparable or improved performance without having to generate preferences or train a reward model, resulting in training that requires less processing and memory usage.

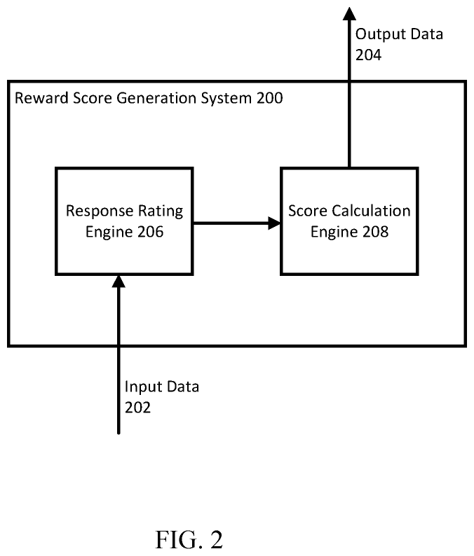

FIG. 2 depicts a block diagram of a reward score generation system 200. The reward score generation system 200 can be implemented on one or more computing devices in one or more locations, such as part of the one or more generative models 102 as depicted in FIG. 1.

The reward score generation system 200 can be configured to receive input data 202. For example, the reward score generation system 200 can receive the input data 202 as part of a call to an application programming interface (API) exposing the reward score generation system 200 to one or more computing devices. The input data 202 can also be provided to the reward score generation system 200 through a storage medium, such as remote storage connected to one or more computing devices over a network. The input data 202 can further be provided as input through a user interface on a client computing device coupled to the reward score generation system 200. The user interface can include a natural language interface, such as one or more text boxes, and/or a graphical interface, such as one or more sliders, checkboxes, and/or templates. The user interface can be configured to receive input as natural language in a variety of different modalities, for example as text input to a text box and/or as an image, a video, and/or audio.

The input data 202 can include model-generated responses for a particular downstream task. The downstream task can be any task performed by a machine learning model, such as classification, text generation, image generation, and/or question answering. Example text generation tasks can include summarization or chatbot dialogue generation.

The input data 202 can further include a prompt to generate a reward score based on the model-generated responses. The prompt can include instructions for rating a quality of the model-generated responses and attributes to consider for rating the quality. For example, the prompt can include instructions to rate the model-generated responses on a scale, such as a scale from 1 to 10 where 1 is lower quality and 10 is higher quality, or a grade, such as a grade from A to F where F is lower quality and A is higher quality. As another example, the prompt can include instructions to rate the model-generated responses with a binary rating, such as preferred or not preferred.

The prompt can further include one or more attributes to take into account when rating the quality of the model-generated responses as well as descriptions for the respective attributes. Example attributes can include length, accuracy, tone, and/or objectives for the response. Example descriptions for the attributes can include describing that length should be within a threshold amount of characters, words, paragraphs, etc., accuracy should be above a threshold percentage, and/or objectives describing the downstream task the response for which the response can be utilized. For example, a summarization task can include attributes that response length should be less than 500 words while maintaining an accuracy above 80%. As another example, a dialogue generation task for a chatbot can include attributes that response length should be one or two sentences while maintaining a cheerful tone.

From the input data 202, the reward score generation system 200 can be configured to output one or more results generated as output data 204. As an example, the reward score generation system 200 can be configured to send the output data 204 for display on a client or user display. As another example, the reward score generation system 200 can be configured to provide the output data 204 as a set of computer-readable instructions, such as one or more computer programs. The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices. The computer programs can also implement functionality described herein, for example, as performed by a system, engine, module, or model. The reward score generation system 200 can further be configured to forward the output data 204 to one or more other devices configured for translating the output data into an executable program written in a computer programming language. The reward score generation system 200 can also be configured to send the output data 204 to a storage device for storage and later retrieval.

The output data 204 can include one or more reward scores indicative of the quality of the model-generated responses. For example, the reward scores can be scalar numbers to be utilized in reinforcement learning for training the model that generated the responses. As another example, the reward scores can be vectors to be utilized in reinforcement learning, where each element of the vector is a scalar number indicative of the quality of a respective attribute for the model-generated response. The reward scores can be normalized and/or weighted for use as a learnable parameter in the reinforcement learning.

The reward score generation system 200 can include a response rating engine 206 and a score calculation engine 208. The response rating engine 206 and score calculation engine 208 can be implemented as one or more computer programs, specially configured electronic circuitry, or any combination thereof.

The response rating engine 206 can be configured to rate the quality of the model-generated responses and generate a rating for each model-generated response. The response rating engine 206 can rate the quality of the model-generated responses based on the instructions and attributes. As an example, the rating can be a scalar number from 1 to 10, where 1 is lower quality and 10 is higher quality.

The score calculation engine 208 can be configured to generate reward scores for the model-generated responses from the ratings. The score calculation engine 208 can calculate a probability weighted average of the ratings to generate respective reward scores for each of the responses. The score calculation engine 208 can further normalize the probability weighted average of ratings in generating the reward scores. For example, the score calculation engine 208 can compute a likelihood of each reward score between 1 and 10 based on respective ratings. The score calculation engine 208 can normalize the likelihoods to a probability distribution. The score calculation engine 208 can calculate a weighted reward score as s(c)=Σᵢ₌₁¹⁰iP(x, c), where c represents a candidate response, e.g., the model-generated responses, and x represents the prompt. The score calculation engine 208 can again normalize the weighted reward score to be within a range, such as [−1, 1]. The normalized weighted reward score can be output for use in reinforcement learning.

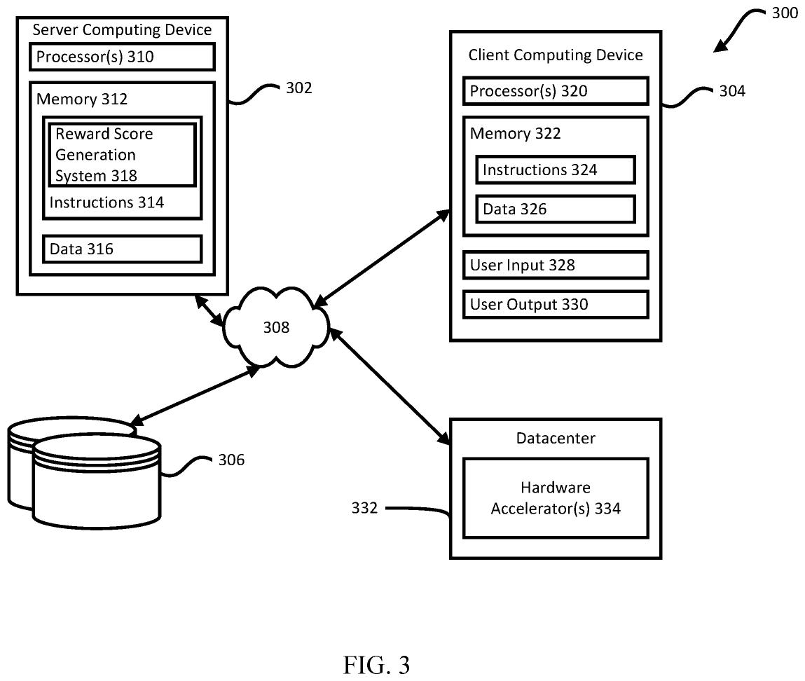

FIG. 3 depicts a block diagram of an example environment 300 for implementing a reward score generation system 318. The reward score generation system 318 can be implemented on one or more devices having one or more processors in one or more locations, such as in server computing device 302. Client computing device 304 and the server computing device 302 can be communicatively coupled to one or more storage devices 306 over a network 308. The storage devices 306 can be a combination of volatile and non-volatile memory and can be at the same or different physical locations than the computing devices 302, 304. For example, the storage devices 306 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 302 can include one or more processors 310 and memory 312. The memory 312 can store information accessible by the processors 310, including instructions 314 that can be executed by the processors 310. The memory 312 can also include data 316 that can be retrieved, manipulated, or stored by the processors 310. The memory 312 can be a type of transitory or non-transitory computer readable medium capable of storing information accessible by the processors 310, such as volatile and non-volatile memory. The processors 310 can include one or more central processing units (CPUs), graphic processing units (GPUs), field-programmable gate arrays (FPGAs), and/or application-specific integrated circuits (ASICs), such as tensor processing units (TPUs).

The instructions 314 can include one or more instructions that, when executed by the processors 310, cause the one or more processors 310 to perform actions defined by the instructions 314. The instructions 314 can be stored in object code format for direct processing by the processors 310, or in other formats including interpretable scripts or collections of independent source code modules that are interpreted on demand or compiled in advance. The instructions 314 can include instructions for implementing a reward score generation system 318, which can correspond to the reward score generation system 200 as depicted in FIG. 2. The reward score generation system 318 can be executed using the processors 310, and/or using other processors remotely located from the server computing device 302.

The data 316 can be retrieved, stored, or modified by the processors 310 in accordance with the instructions 314. The data 316 can be stored in computer registers, in a relational or non-relational database as a table having a plurality of different fields and records, or as JSON, YAML, proto, or XML documents. The data 316 can also be formatted in a computer-readable format such as, but not limited to, binary values, ASCII, or Unicode. Moreover, the data 316 can include information sufficient to identify relevant information, such as numbers, descriptive text, proprietary codes, pointers, references to data stored in other memories, including other network locations, or information that is used by a function to calculate relevant data.

The client computing device 304 can also be configured similarly to the server computing device 302, with one or more processors 320, memory 322, instructions 324, and data 326. The client computing device 304 can also include a user input 328 and a user output 330. The user input 328 can include any appropriate mechanism or technique for receiving input from a user, such as keyboard, mouse, mechanical actuators, soft actuators, touchscreens, microphones, and sensors.

The server computing device 302 can be configured to transmit data to the client computing device 304, and the client computing device 304 can be configured to display at least a portion of the received data on a display implemented as part of the user output 330. The user output 330 can also be used for displaying an interface between the client computing device 304 and the server computing device 302. The user output 330 can alternatively or additionally include one or more speakers, transducers or other audio outputs, a haptic interface or other tactile feedback that provides non-visual and non-audible information to the platform user of the client computing device 304.

Although FIG. 3 illustrates the processors 310, 320 and the memories 312, 322 as being within the respective computing devices 302, 304, components described herein can include multiple processors and memories that can operate in different physical locations and not within the same computing device. For example, some of the instructions 314, 324 and the data 316, 326 can be stored on a removable SD card and others within a read-only computer chip. Some or all of the instructions 314, 324 and data 316, 326 can be stored in a location physically remote from, yet still accessible by, the processors 310, 320. Similarly, the processors 310, 320 can include a collection of processors that can perform concurrent and/or sequential operation. The computing devices 302, 304 can each include one or more internal clocks providing timing information, which can be used for time measurement for operations and programs run by the computing devices 302, 304.

The server computing device 302 can be connected over the network 308 to a data center 332 housing any number of hardware accelerators 334. The data center 332 can be one of multiple data centers or other facilities in which various types of computing devices, such as hardware accelerators, are located. Computing resources housed in the data center 332 can be specified for deploying models, such as for reward score generation, as described herein.

The server computing device 302 can be configured to receive requests to process data from the client computing device 304 on computing resources in the data center 332. For example, the environment 300 can be part of a computing platform configured to provide a variety of services to users, through various user interfaces and/or application programming interfaces (APIs) exposing the platform services. As an example, the variety of services can include generating reward scores for training machine learning models with reinforcement learning. The client computing device 304 can transmit input data as part of a query for a task to generate a reward score for reinforcement learning for a particular task. The reward score generation system 318 can receive the input data, and in response, generate output data including a response to the query including the generated reward score.

The server computing device 302 can maintain a variety of models in accordance with different constraints available at the data center 332. For example, the server computing device 302 can maintain different families for deploying models on various types of TPUs and/or GPUs housed in the data center 332 or otherwise available for processing.

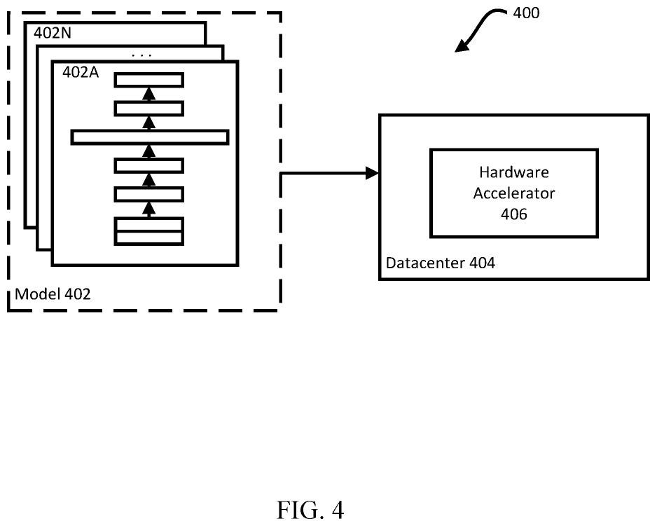

FIG. 4 depicts a block diagram 400 illustrating one or more machine learning model 402 architectures, more specifically 402A-N for each architecture, for deployment in a datacenter 404 housing a hardware accelerator 406 on which the deployed machine learning models 402 will execute, such as for the variety of services as described herein. The hardware accelerator 406 can be any type of processor, such as a CPU, GPU, FPGA, or ASIC such as a TPU.

An architecture of a machine learning model 402 can refer to characteristics defining the model, such as characteristics of layers for the model, how the layers process input, or how the layers interact with one another. The architecture of the machine learning model 402 can also define types of operations performed within each layer. One or more machine learning model 402 architectures can be generated that can output results, such as for generating reward scores for training machine learning models with reinforcement learning. Example model architectures can correspond to generative models, such as language models, foundation models, and/or graphical models.

The machine learning models can be trained according to a variety of different learning techniques. Learning techniques for training the machine learning models can include supervised learning, unsupervised learning, semi-supervised learning, and reinforcement learning techniques. For example, training data can include multiple training examples that can be received as input by a model. The training examples can be labeled with a desired output for the model when processing the labeled training examples. The label and the model output can be evaluated through a loss function to determine an error, which can be back propagated through the model to update weights for the model. For example, a supervised learning technique can be applied to calculate an error between outputs, with a ground-truth label of a training example processed by the model. Any of a variety of loss or error functions appropriate for the type of the task the model is being trained for can be utilized, such as cross-entropy loss for classification tasks, or mean square error for regression tasks. The gradient of the error with respect to the different weights of the candidate model on candidate hardware can be calculated, for example using a backpropagation algorithm, and the weights for the model can be updated.

As another example, with respect to reinforcement learning, situations encountered by an agent, e.g., a model, a computing device, a system, a robot, etc., are mapped to actions taken by the agent in those situations to maximize the reward or value of its actions. The agent can interact with an environment through its actions. At any given time or point at which the agent is able to act, the environment can be represented as a state. The state can include any information or features about the environment that can be known by the agent. The value of a state is a measure of the total amount of reward the agent can receive from the current state and future states accessible from the current state. A value function can be defined or estimated for calculating, predicting, or estimating the value of a state. Techniques for training a machine learning model via reinforcement learning can focus on estimating or learning value functions to accurately predict value across different states of an environment.

The agent applies a policy to determine an action to take given the state of the environment. The policy can be stochastic, deterministic, or a mixture of the two. The agent can be provided a reward signal or value in response to performing the action, which can be positive, negative, or neutral. The action taken by the agent can advance the environment to a new state with an objective being to maximize the value of a state brought upon by the agent performing an action. Example reinforcement learning techniques include multi-armed bandits, Markov decision processes, Monte Carlo methods, policy gradient methods, and/or other approximate solution methods. Other approaches in reinforcement learning may not rely on estimating value functions.

The model or policy can be modified or updated until stopping criteria are met, such as a number of iterations for training, a maximum period of time, a convergence of estimated rewards or value between actions, or when a minimum value threshold is met.

Referring back to FIG. 3, the devices 302, 304 and the data center 332 can be capable of direct and indirect communication over the network 308. For example, using a network socket, the client computing device 304 can connect to a service operating in the data center 332 through an Internet protocol. The devices 302, 304 can set up listening sockets that may accept an initiating connection for sending and receiving information. The network 308 can include various configurations and protocols including the Internet, World Wide Web, intranets, virtual private networks, wide area networks, local networks, and private networks using communication protocols proprietary to one or more companies. The network 308 can support a variety of short-and long-range connections. The short-and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network 308, in addition or alternatively, can also support wired connections between the devices 302, 304 and the data center 332, including over various types of Ethernet connection.

Although a single server computing device 302, client computing device 304, and data center 332 are shown in FIG. 3, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device connected to hardware accelerators configured for processing machine learning models, or any combination thereof.

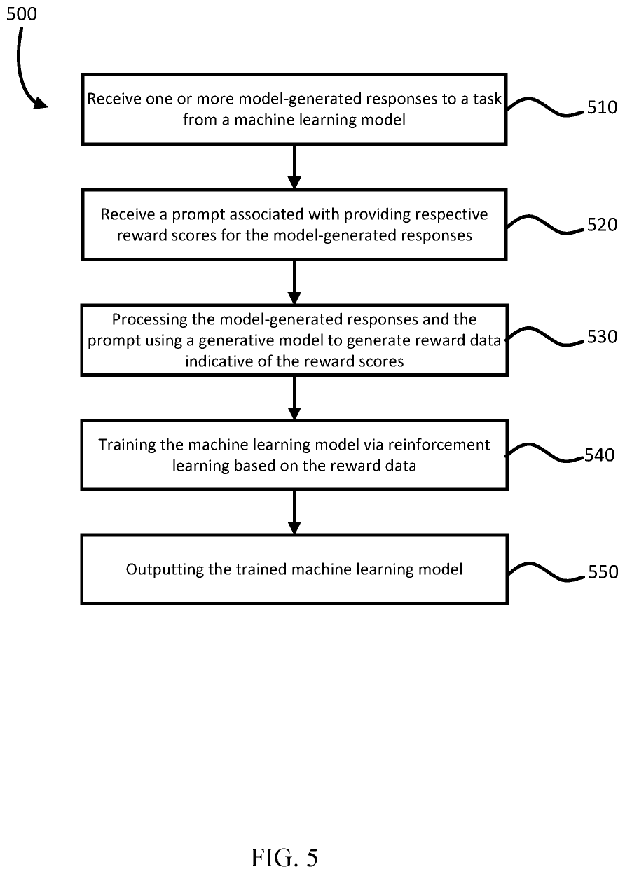

FIG. 5 depicts a flow diagram of an example process 500 for training a machine learning model with reinforcement learning. The example process 500 can be performed on a system of one or more processors in one or more locations, such as the reinforcement learning trainer 100 as depicted in FIG. 1.

As shown in block 510, the reinforcement learning trainer 100 receives one or more model-generated responses to a task from a machine learning model. The machine learning model can be a supervised fine-tuning (SFT) model pre-trained for a particular downstream task using labeled data. The downstream task can be a text generation task, such as summarization or dialogue generation.

As shown in block 520, the reinforcement learning trainer 100 receives a prompt associated with providing respective reward scores for each model-generated response. The prompt can include instructions to rate a quality of each model-generated response. For example, the instructions can include rating the quality of each model-generated response numerically on a scale from 1 to 10. The instructions can further include one or more attributes to consider in rating the quality of each model-generated response, such as length, accuracy, and/or tone. The instructions can also include descriptions for the one or more attributes, such as length should be less than a predetermined threshold amount.

As shown in block 530, the reinforcement learning trainer 100 processes the model-generated responses and the prompt using a generative model to generate reward data indicative of the reward scores. The generative model can be a large generative model, such as a large language model, large foundation model, and/or large graphical model. The generative model can calculate a probability weighted average of ratings for the quality of each model-generated response to generate the reward scores. The generative model can further normalize the probability weighted average such that the reward score is within a threshold numerical range.

As shown in block 540, the reinforcement learning trainer 100 trains the machine learning model via reinforcement learning based on the reward data. The reinforcement learning trainer 100 can utilize policy-gradient-based techniques to train the machine learning model. For example, the reinforcement learning trainer 100 can train the machine learning model using reinforce techniques with a value function adapted to a language domain or a policy optimization technique where a scores from the environment in response to actions for a plurality of sequences in parallel are gathered to then provide an estimated gradient direction that optimizes the reward.

As shown in block 550, the reinforcement learning trainer 100 can output the trained machine learning model. The trained machine learning model can be used in the particular downstream task, such as the text generation task.

Aspects of this disclosure can be implemented in digital electronic circuitry, in tangibly embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus.

The term “configured” is used herein in connection with systems and computer program components. For a system of one or more computers to be configured to perform particular operations or actions means that the system has installed thereon software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” or “data processing system” refers to data processing hardware and encompasses various apparatus, devices, and machines for processing data, including programmable processors, computers, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for scaling reinforcement learning comprising:
receiving, by one or more processors, model-generated responses to a task and a prompt associated with providing respective reward scores for the model-generated responses;
processing, by the one or more processors, the model-generated responses and the prompt using a generative model to generate reward data indicative of the reward scores;
training, by the one or more processors, one or more machine learning models via reinforcement learning based on the reward data; and
outputting, by the one or more processors, the one or more trained machine learning models.

2. The method of claim 1, wherein the generative model is at least one of a large language model, large foundation model, or large graphical model.

3. The method of claim 1, wherein the prompt comprises instructions for the generative model to rate a quality of the respective responses.

4. The method of claim 3, wherein the instructions comprise rating the quality of the respective responses on a scale.

5. The method of claim 3, wherein the instructions further comprise one or more attributes for the generative model to consider in rating the quality of the respective responses.

6. The method of claim 5, wherein the instructions further comprise descriptions for the one or more attributes.

7. The method of claim 1, wherein processing the model-generated responses and the prompt further comprises calculating a probability weighted average of ratings to generate the reward scores.

8. The method of claim 7, wherein processing the model-generated responses and the prompt further comprises normalizing the probability weighted average of ratings.

9. The method of claim 1, wherein the one or more machine learning models are trained via reinforcement learning based on policy-gradient-based techniques.

10. The method of claim 1, wherein the task comprises at least one of summarization or dialogue generation.

11. A system comprising:
one or more processors; and
one or more storage devices coupled to the one or more processors and storing instructions that, when executed by the one or more processors, cause the one or more processors to perform operations for scaling reinforcement learning, the operations comprising:
receiving model-generated responses to a task and a prompt associated with providing respective reward scores for the model-generated responses;
processing the model-generated responses and the prompt using a generative model to generate reward data indicative of the reward scores;
training one or more machine learning models via reinforcement learning based on the reward data; and
outputting the one or more trained machine learning models.

12. The system of claim 11, wherein the generative model is at least one of a large language model, large foundation model, or large graphical model.

13. The system of claim 11, wherein the prompt comprises instructions for the generative model to rate a quality of the respective responses.

14. The system of claim 13, wherein the instructions comprise rating the quality of the respective responses on a scale.

15. The system of claim 13, wherein the instructions further comprise one or more attributes for the generative model to consider in rating the quality of the respective responses.

16. The system of claim 15, wherein the instructions further comprise descriptions for the one or more attributes.

17. The system of claim 11, wherein processing the model-generated responses and the prompt further comprises calculating a probability weighted average of ratings to generate the reward scores.

18. The system of claim 17, wherein processing the model-generated responses and the prompt further comprises normalizing the probability weighted average of ratings.

19. The system of claim 11, wherein the one or more machine learning models are trained via reinforcement learning based on policy-gradient-based techniques.

20. A non-transitory computer readable medium for storing instructions that, when executed by one or more processors, cause the one or more processors to perform operations for scaling reinforcement learning, the operations comprising:
receiving model-generated responses to a task and a prompt associated with providing respective reward scores for the model-generated responses;
processing the model-generated responses and the prompt using a generative model to generate reward data indicative of the reward scores;
training one or more machine learning models via reinforcement learning based on the reward data; and
outputting the one or more trained machine learning models.
